(19) United States
(12) Patent Application Publication
(10) Pub. No.: US 2021/0123767 A1
(43) Pub. Date: Apr. 29, 2021

(54) SYSTEM HAVING TRAVEL GUIDANCE AND REALITY GAMES

(71) Applicants: LAI-CHENG CHEN, PINGTUNG COUNTY (TW); TSUNG-YI HSIEH, KAOHSIUNG CITY (TW)

(72) Inventors: LAI-CHENG CHEN, PINGTUNG COUNTY (TW); TSUNG-YI HSIEH, KAOHSIUNG CITY (TW)

(21) Appl. No.: 16/665,429

(22) Filed: Oct. 28, 2019

(51) Int. Cl. G01C 21/36; G01C 21/20; G06T 19/00; G08G 1/0969; G09B 29/10; G06F 3/01; G06K 9/00

(52) U.S. Cl. CPC G01C 21/3647; G01C 21/3602; G01C 21/20; G06K 9/00671; G08G 1/0969; G09B 29/10; G06F 3/01; G06T 19/006

(57) ABSTRACT

A system includes a server, a mobile device with a positioning unit, and an operation module. The server has a mascot database and a map database where main areas are defined. The positioning unit determines a current location of the mobile device for navigation. The operation module includes a mascot collecting unit linked to the mascot database, a photograph collecting unit linked to the map database, and a camera module connected to both collecting units. When the current location corresponds to a main position of one main area, at least one mascot linked to the main area is incorporated into the mascot collecting unit so that the mascot, a real scene of the main area, and the user are caught in a frame by the camera module to form and store a picture in the photograph collecting unit, thereby enjoying collecting mascots and combining travel guidance with reality games.

### BACKGROUND OF THE INVENTION

### 1. Field of the Invention

This invention relates to the application software and relates particularly to a system which combines travel guidance with reality games.

### 2. Description of the Related Art

With the enormous development of the Internet, more and more people search for information about scenic areas on the Internet before travelling, take pictures during travelling, and then register in social networking sites or personal blogs to share their pictures about their travels with public or their friends or to keep the pictures which remind themselves of special occasions or places they have visited. Some common travelling software can be used and be adapted to indicate brief introductions about scenic areas. However, the travelling software only indicates names of these scenic areas but fails to indicate their precise positions, so users need to spend time searching for details about the areas they have visited or will visit by themselves. It is also possible that the searched details are not correct or are not updated. Generally, the software does not manage scenes of the visited areas and does not keep records about travels of the users. Therefore, the users lose interest in the common travelling software easily, and the duration of using the travelling software is short. Similarly, when the popularity of a game is declined, users may delete its game software directly or lose interest in playing the game if the game software lacks reality information or real pictures of the users and is meaningless to the users.

### SUMMARY OF THE INVENTION

The object of this invention is to provide a system which combines travel guidance with reality games to allow users to have the joys of collecting mascots and taking pictures with mascots in different main areas and also enjoy their travels by the guidance of the system.

The system having travel guidance and reality games of this invention includes a server, a mobile device, and an operation module. The server includes a map database and a mascot database. The map database has at least one map which defines a plurality of main areas according to respective main positions. The map is displayed on a screen of the mobile device. The mascot database has a plurality of mascots formed therein, and at least one of the mascots is liked to each main area. The mobile device is carried by a user and has a positioning unit by which a current location of the mobile device on the map is determined to thereby obtain a positioning data. The positioning unit is adapted to recognize the main positions of the main areas, thereby allowing the user to be navigated from the current location to the main positions of the main areas. The operation module is installed in the mobile device and is used in conjunction with the positioning unit. The operation module includes a mascot collecting unit linked to the mascot database, a photograph collecting unit linked to the map database, and a camera module respectively connected to the mascot collecting unit and the photograph collecting unit. The mascot collecting unit has a plurality of mascot stamps corresponding to the respective mascots, and the photograph collecting unit has a plurality of area stamps corresponding to the respective main areas. Accordingly, when one of the main areas is selected, the user is guided to the selected main area for looking around the selected main area and searching the selected main area for at least one mascot at the same time. When the mascot within the selected main area is found, the camera module can be operated to allow the user to take a picture with the mascot in the selected main area. Thus, the mascot, a real scene of the selected main area, and the user are all caught in a frame, thereby forming a picture. The picture is stored in the photograph collecting unit so that a corresponding area stamp related to the selected main area is unlocked. Therefore, the system attains the function of travel guidance and allows the user to collect different mascots and take pictures with mascots and real scenes and to enjoy his travels by following the guidance of the system.

Preferably, the operation module includes a drawing module linked to the map database, thereby selecting one main area from the map database at random.

Preferably, the map database can further define a plurality of subsidiary areas linked to each main area. Each of the subsidiary areas has a positioning member whereby the positioning unit recognizes respective subsidiary positions of the subsidiary areas for determining whether the user is located within any of the subsidiary areas and for navigating the user to subsidiary areas.

Preferably, the system can further include a payment system which has an electronic wallet installed in the operation module. Digital money is saved in the electronic wallet. It is also possible that the operation module further includes a processing unit adapted to calculate steps made by the user, convert the calculation into virtual coin, and then convert the virtual coin into the digital money according to a predefined exchange rate, thereby having the joys of collecting mascots and purchasing goods during the travels of the user.

### BRIEF DESCRIPTION OF THE DRAWINGS

FIG. 1 is a block diagram showing components of a system of a first preferred embodiment of this invention;

FIG. 2 is a flowchart showing execution steps of the first preferred embodiment of this invention for collecting mascots and creating pictures;

FIG. 3 is a schematic view showing an interface of the mascot collecting unit of this invention in which the mascot stamps are still locked;

FIG. 3A is a schematic view showing a mascot stamp is unlocked in the mascot collecting unit.

FIG. 4 is a schematic view showing an interface of the photograph collecting unit of this invention in which the area stamps are still locked;

FIG. 4A is a schematic view showing an area stamp is unlocked in the photograph collecting unit;

FIG. 4B is a schematic view showing a complete picture taken by the camera module of this invention within one main area;

FIG. 5 is a flowchart showing execution steps of the first preferred embodiment of this invention for executing guidance when a user is located within a main area; and

FIG. 6 is a flowchart showing execution steps of the first preferred embodiment of this invention in which a processing unit is used to make the calculation and conversions into virtual coin and then into digital money.

### DETAILED DESCRIPTION OF THE PREFERRED EMBODIMENTS

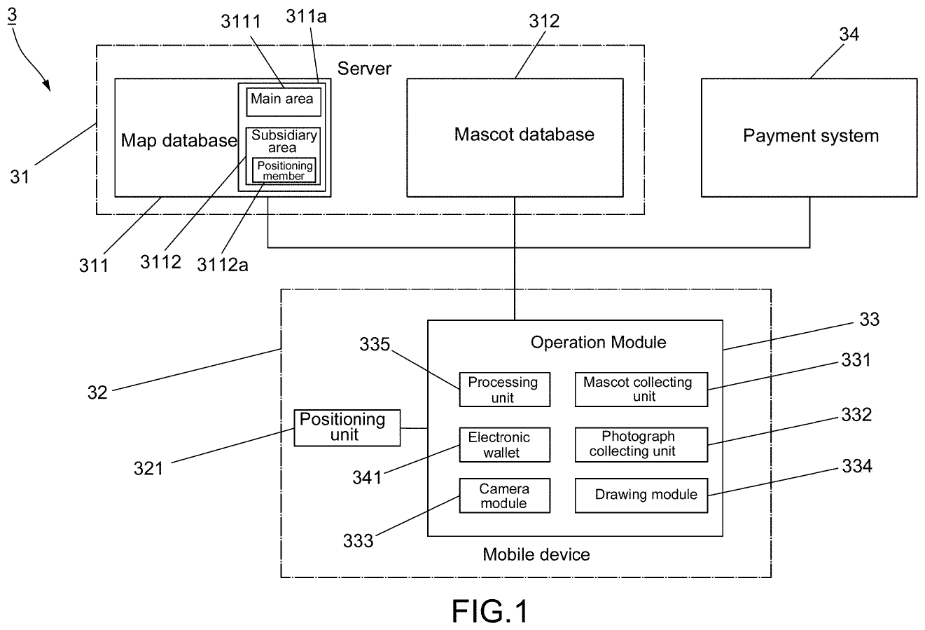

Referring to FIGS. 1 through 4B, a first preferred embodiment of a system 3 having travel guidance and reality games includes a server 31, a mobile device 32, and an operation module 33 installed in the mobile device 32. The server 31 includes a map database 311 and a mascot database 312. The map database 311 has at least one map 311a on which a plurality of main areas 3111 can be defined and shown according to respective main positions. The map 311a can be a region map showing a representation of a city, a country, or a town of a nation and can be provided by Google Maps, Baidu Maps, or other web mapping applications. The map 311a is displayed on a screen of the mobile device 32, thereby allowing a user to check where the main areas 3111 are situated. The main areas 3111 shown on the map 311a can be scenic areas, department stores, concert halls, exhibition halls, amusement parks, theme parks, zoos, or special landmarks and spots. A plurality of mascots B can be formed or built and saved in the mascot database 312. The mascot database 312 can be relevant to each of the main areas 3111, such as a scenic area, an amusement park, and a zoo. The main area 3111 is directly selected by a user or is randomly picked by a drawing module 334 which will be described as follows. Each main area 3111 contains at least one mascot. In other words, at least one mascot B, as for example shown in FIG. 48, is linked to each main area 3111. The type of the mascot B within the same main area 3111 can be changed at predefined intervals in order to increase the willingness of the user to visit the same main area 3111 repeatedly.

The mobile device 32 is carried by the user. A positioning unit 321 is installed in the mobile device 21 and combines with the operation module 33 for collecting mascots B and offering guidance of the route at the same time. The positioning unit 321 can be a positioning system, such as GPS and iBeacon, in order to determine where the mobile device 32 is located, namely to find out a coordinate of a current location of the mobile device 32 on the map 311a. Then, a positioning data is obtained by the determination, namely the determined result. The positioning unit 321 also recognizes the main positions of the main areas 3111 and determines whether the operation module 33 is located within any of the main areas 3111, thereby providing navigation to guide the user from the current location to the main areas 3111.

The operation module 33 includes a mascot collecting unit 331 linked to the mascot database 312, a photograph collecting unit 332 linked to the map database 311, and a camera module 333 respectively connected to the mascot collecting unit 331 and the photograph collecting unit 332. Information about mascots B is displayed in the mascot collecting unit 331, and information about the main areas 3111 is displayed in the photograph collecting unit 332. Preferably, the operation module 33 further includes a drawing module 334 linked to the map database 311. The drawing module 334 selects or picks one main area 3111 from the map database 311 at random so that the user decides whether to travel in the randomly selected main area 3111.

The use of the drawing module 334 decides where to go automatically and thus it is suitable for free users who do not designate any main areas 3111, thereby having the joy of traveling everywhere.

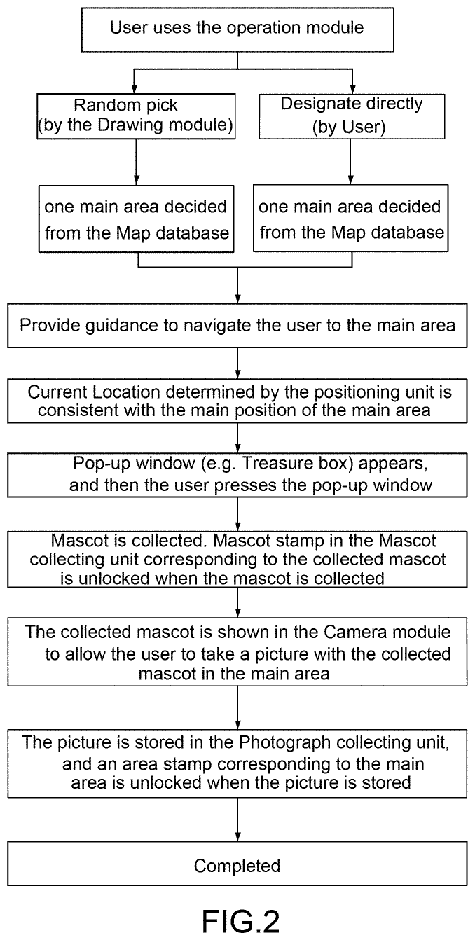

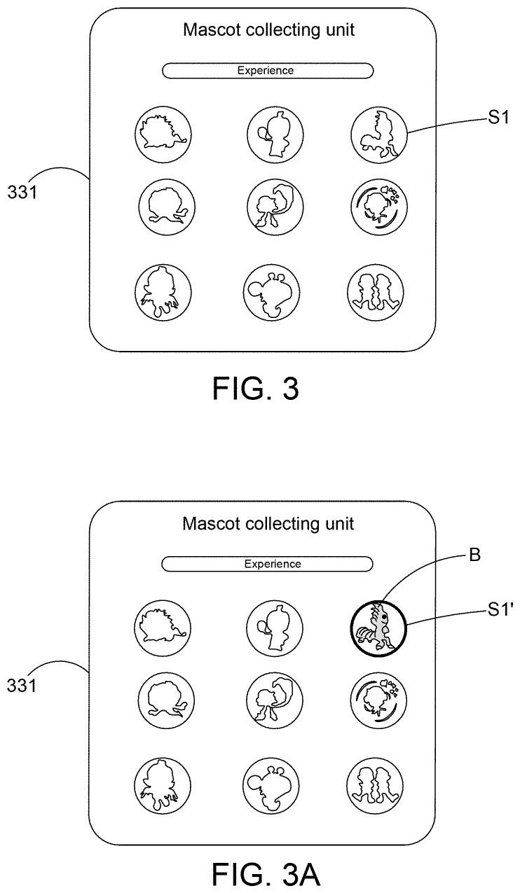

The mascot collecting unit 331 has a plurality of mascot stamps corresponding to the respective mascots B, and at least one of the mascots B appears in each main area 3111, as previously indicated. The mascot stamps are initially preset in a locked state, as locked mascot stamps S1 shown in FIG. 3. When the positioning data representing the current location of the mobile device 32 is consistent with a main position of one main area 3111, a mascot B within the main area 3111 will be found and be put into the mascot collecting unit 331. When the mascot B is incorporated into the mascot collecting unit 331, a corresponding mascot stamp, namely a mascot stamp corresponding to the found mascot B, is unlocked automatically to become an unlocked mascot stamp S1′, as shown in FIG. 3A. It is also possible that the locked mascot stamp S1 is manually unlocked, as adopted in FIG. 2. For example, when the mascot B is found, a pop-up window, presented by a treasure box, special contours, or word notifications, appears firstly, and then the user needs to tap his finger on the pop-up window to unlock its corresponding mascot stamp, thereby having the joy of collecting different mascots.

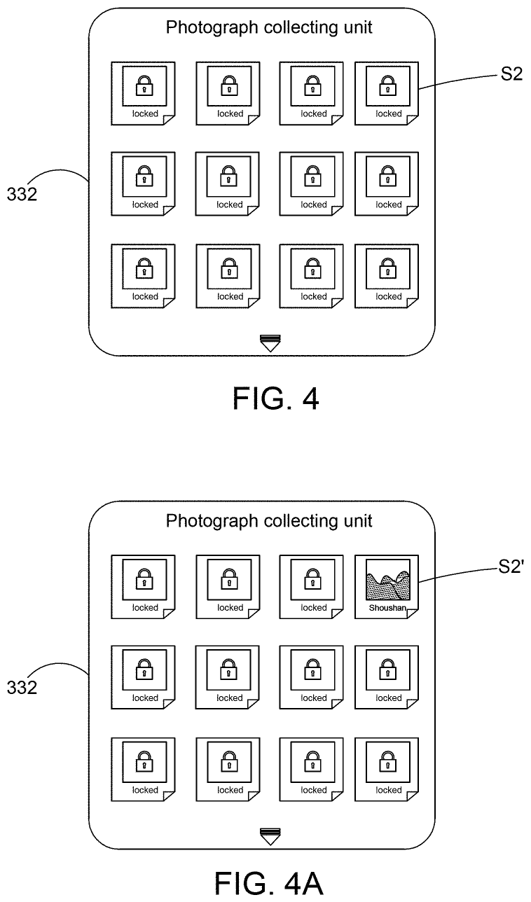

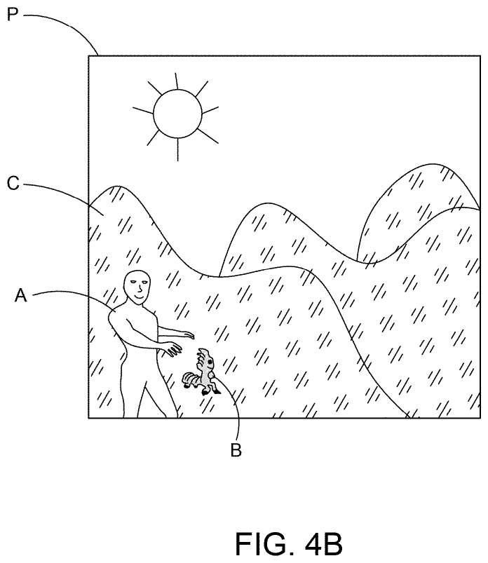

Further, the photograph collecting unit 332 has a plurality of area stamps corresponding to the respective main areas 3111. The area stamps are initially preset in a locked state, as locked area stamps S2 shown in FIG. 4. When the user is located within one main area 3111 and finds a mascot B, the camera module 333 can be triggered by the user to allow the user to take a picture with the mascot in the visited main area 3111. Specifically, the user A, the found mascot B, and the real scene C of the visited main area 3111 are all caught in a frame to form a picture P, as shown in FIG. 4B, and then the picture P is stored in the photograph collecting unit 332. When the picture P is stored, one of the area stamps S2 corresponding to the visited main area 3111 is unlocked to become an unlocked area stamp S2′, as shown in FIG. 4A. If the user presses the unlocked area stamp S2′, all pictures P taken in the selected main area 3111 are displayed.

Accordingly, while collecting different mascots B and their corresponding unlocked mascot stamps S1′, the user takes pictures with different mascots B in different main areas 3111 and stores the pictures P in the photograph collecting unit 332 to thereby have the joys of collecting mascots, travelling in different places, and taking real pictures as souvenirs. Furthermore, the function of storing the pictures P in the photograph collecting unit 33 also helps lower the probability of deleting the system 3 because the stored pictures P include the real image of the user A and serve as souvenirs which remind the user of special occasions or places they have visited.

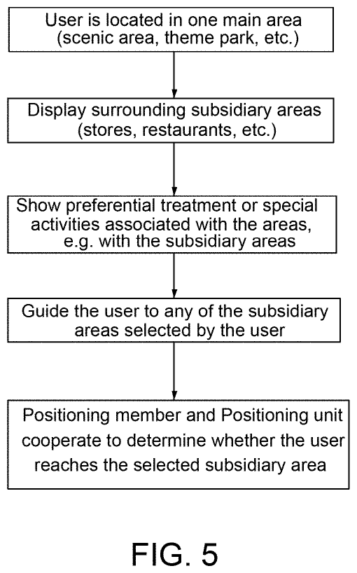

Referring to FIGS. 1 and 5, it is preferable that the map database 311 further defines a plurality of subsidiary areas 3112 linked to each of the main areas 3111. The subsidiary areas 3112 may be areas relevant to each main area 3111. Each of the subsidiary areas 3112 has a positioning member 3112a capable of being detected or recognized by the positioning unit 321 of the mobile device 32, thereby showing respective subsidiary positions of the subsidiary areas 3112 on the map 311a and allowing the positioning unit 321 to determine whether the user is located in a subsidiary area 3112 or which subsidiary area 3112 the user is located. The positioning member 3112a cab be GPS, iBeacon, image recognition components, or other suitable positioning devices. Accordingly, when the user is located within a specific main area 3111, he can search for surrounding subsidiary areas 3112 related to the specific main area 3111. The subsidiary areas 3112 can be special exhibition rooms, stores, restaurants, or special spots within or near the specific main area 3111. When the user selects one of the subsidiary areas 3112 like a convenient store, he is guided to the selected store for looking around that store or purchasing goods in that store. It is also possible to display preferential treatment or special activities associated with the store on the screen of the mobile device 32. Therefore, the use of the positioning members 3112a not only informs the user of the precise positions of the subsidiary areas 3112 of the main area 3111 but also helps corresponding guidance or navigation to thereby increase adding values of the system 3 and increase the customer flow of the subsidiary areas 3112. The displayed preferential treatment or special activities can also increase the willingness of the user to visit those subsidiary areas 3112 or buy goods there, thereby being profitable to both of the user and subsidiary areas 3112.

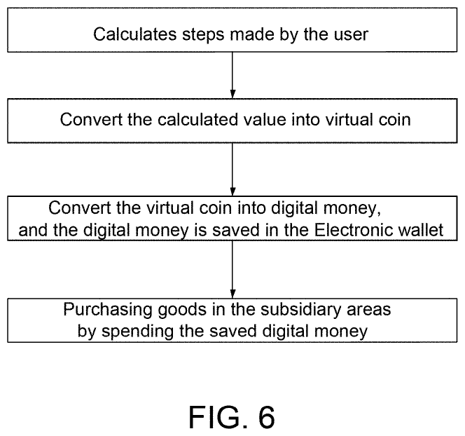

Referring to FIGS. 1 and 6, it is preferable that the system 3 further includes a payment system 34. The payment system 34 includes an electronic wallet 341 installed in the operation module 33. The operation module 33 further includes a processing unit 335. The processing unit 335 is triggered when the user uses the operation module 33. Specifically, the processing unit 335 calculates the number of steps made by the user to attain a calculated value. The steps can be made when the user walks. Then, the processing unit 335 converts the calculated value into virtual coin and further convert the virtual coin into digital money according to a predefined exchange rate. The digital money is saved in the electronic wallet 341. Therefore, the user can spend the converted digital money in the stores which accept the payment of the digital money, preferably in the subsidiary areas 3112, thereby adding the joy of purchasing and attaining the practicability during his travels.

To sum up, the system of this invention takes advantage of a mascot collecting unit, a photograph collecting unit, and a cameral module to cooperate with a server and a positioning unit of a mobile device, thereby guiding a user to main areas of the server and allowing the user to take pictures with different mascots in different real scenes of the main areas and to store the taken pictures as souvenirs. Therefore, the system combines the travel guidance with reality games to thereby have the joy of collecting mascots and real pictures and enjoy travel guidance. Furthermore, the stored pictures which contain the image of the user in the photograph collecting unit can serve as souvenirs, so the user has an increasing willingness to keep using the system and lowers the probability of deleting the system.

While the embodiments are shown and described above, it is understood that further variations and modifications may be made without departing from the scope of this invention.

What is claimed is:

1. A system having travel guidance and reality games comprising:
a server including a map database and a mascot database, said map database having at least one map on which a plurality of main areas are defined and shown according to respective main positions, said mascot database having a plurality of mascots formed therein, at least one of said plurality of mascots being linked to each of said plurality of main areas;
a mobile device adapted to be carried by a user, said at least one map being displayed on a screen of said mobile device, said mobile device having a positioning unit whereby a positioning data is obtained by determining a current location of said mobile device on said at least one map, said positioning unit being adapted to recognize said main positions of said plurality of main areas and navigate said user from said current location to said main positions of said plurality of main areas; and
an operation module installed in said mobile device, said operation module being operated in conjunction with said positioning unit, said operation module including a mascot collecting unit linked to said mascot database, a photograph collecting unit linked to said map database, and a camera module respectively connected to said mascot collecting unit and said photograph collecting unit, said mascot collecting unit having a plurality of mascot stamps corresponding to said plurality of mascots, said plurality of mascot stamps being initially preset in a locked state, said photograph collecting unit having a plurality of area stamps corresponding to said plurality of main areas, said plurality of area stamps being initially preset in a locked state;
wherein when said current location of said positioning data is consistent with one of said main positions corresponding to one of said plurality of main areas, at least one of said plurality of mascots within said one main area being incorporated into said mascot collecting unit, the incorporation of said at least one mascot into said mascot collecting unit unlocking at least one of said plurality of mascot stamps corresponding to said at least one mascot and activating an operation of said camera module whereby said at least one mascot, a user, and a real scene of said one main area are caught in a frame to form a picture, said photograph collecting unit being adapted to store said picture, one of said plurality of area stamps corresponding to said one main area being unlocked when said picture is stored.

2. The system according to claim 1, wherein said operation module includes a drawing module linked to said map database and adapted to select said one main area from said map database at random.

3. The system according to claim 1, wherein said map database defines a plurality of subsidiary areas linked to each of said plurality of main areas, each of said plurality of subsidiary areas having a positioning member whereby said positioning unit recognizes respective subsidiary positions of said plurality of subsidiary areas for further navigation.

4. The system according to claim 1, further comprising a payment system, said payment system including an electronic wallet installed in said operation module.

5. The system according to claim 4, wherein said operation module includes a processing unit adapted to calculate steps made by said user, to convert the calculation into virtual coin, and then to convert said virtual coin into digital money according to a predefined exchange rate, said digital money being saved in said electronic wallet.
